(19) United States
(12) Patent Application Publication
(10) Pub. No.: US 2007/0258102 A1
(43) Pub. Date: Nov. 8, 2007

(54) Proof printing adjustment system and method

(76) Inventors: Richard R. Bielak, Port Coquitlam (CA); Jennifer Laskin Canonayon, Surrey (CA)

Correspondence Address: Mark G. Bocchetti;Patent Legal Staff, Eastman Kodak Company, 343 State Street, Rochester, NY, 14650-2201, US

(21) Appl. No.: 11/429,087

(22) Filed: May 5, 2006

(51) Int. Cl. G06F 15/00

(52) U.S. Cl. 358/1.9

(57) ABSTRACT

A proof printing system and method comprises a printer and supporting firmware for the printer, the printer comprising spectrophotometer integrated with the printer, which printer may be a commercial printer. The supporting firmware comprises color adjustment tables an/or algorithms. The system is capable of color confirmation and color calibration. The proof printing system is capable of adjusting the output signal of the spectrophotometer to compensate for conditions at the time of printing or conditions at the time of spectrophotometric measurement. The system is also capable of predicting the time it takes a color patch to reach a predetermined degree of drying that will allow reliable spectrophotometric measurements to be made. Measurement and printing conditions compensated for include at least drying of the ink, based on the determination of at least one of humidity and temperature. Measurement conditions additionally compensated for include the use of different colors of backing behind the proof and the presence or absence of an ultraviolet cutoff filter. The proof printing system can also adjust the output signal of the spectrophotometer based on a reference color standard.

### FIELD OF THE INVENTION

The present invention relates to a proof printing adjustment system and method. In particular, the present invention relates to a system and method to reduce the time to measure a color in a proof printing system.

### BACKGROUND OF THE INVENTION

It is common to provide a sample of an image to a customer for approval prior to printing a large number of copies of an image using a high volume output device such as a printing press. The sample image is known as a “proof”. The proof is used to ensure that the consumer is satisfied with, among other things, a color of the image.

It is not, however, cost effective to print the proof using high volume output devices of the type used to print large quantities of the image. This is because it is expensive to set up high volume output devices to print the image. Accordingly, it has become a practice in the printing industry to use digital color printers to print proofs. Digital color printers render color prints of images that have been encoded in the form of digital data. This data includes code values indicating the colors to be printed in the image. When the color printer generates a printed output of an image, it is intended that the image recorded on the printed output will contain the exact colors called for by the code values in the digitally encoded data.

In practice, it has been found that colors printed by digital color printers do not always match colors printed by high volume output devices. One reason for this is that variations in ink, paper and printing conditions can cause the digital color printer to generate images with colors that do not match the colors produced by the high volume output device using the same values. Therefore, a proof printed by the digital color printer may not have colors that match the colors printed by the high volume output device.

Accordingly, digital color printers have been developed that can be color adjusted and color confirmed so that they can mimic the performance of high volume output devices. Such adjustable color printers are known in the industry as “proofers”. Two types of adjustments are commonly applied to cause proofers to produce visually accurate proofs of an image, namely color calibration and color management adjustments.

Color calibration adjustments are used to modify the operation of the proofer so that the proofer prints the colors called for in the code values of the images to be printed by the proofer. These adjustments are necessary to compensate for the variations in ink, paper and printing conditions that can cause the colors printed by the proofer to vary from the colors called for in the code values. To determine what color calibration adjustments must be made, it is necessary to determine how the proofer translates code values into colors on the printed image. This is done by asking the proofer to print a calibration test image or so-called “color target.” The calibration test image includes a number of color patches. Each color patch contains the color printed by the proofer in response to a particular code value.

Typically, a manual stand-alone calibration device is used to measure the colors in the test image. The measured color of each color patch is converted into a color code value and is compared against the original “color target” code value associated with that patch. Thereafter, comparisons are used to determine what adjustments must be made to the proofer to cause the proofer to print the desired colors in response to the particular color code values. Color confirmation is a type of quality control that ensures that a desired final color output from the proofer is actually achieved, as specified by industry standards or customer requirements.

Color management adjustments are used to modify the operation of the proofer so that the image printed by the proofer will have an appearance that matches the appearance of the same image as printed by the high volume output device. The first step in color management is to determine how the high volume output device converts color code values into printed colors. This is known as “characterization.” The result of such a characterization process is a “color profile.” To characterize the high volume output device and produce the “color profile,” it is necessary to obtain a characterization test image. The characterization test image can be printed by the high volume output device. However, if it is known that the high volume output device converts code values into printed colors in accordance with industry standards, such as FOGRA (the Graphic Technology Research Association standard (www.fogra.org)) and SWOP (Specifications for Web Offset Printing (www.swop.org)), then the test image printed in accordance with that standard can be used for characterization purposes.

It is recognized that both calibration and color confirmation are based upon objective measurements of the color and tone characteristics of test images printed by the proofer and high volume output device. The most accurate device for measuring color for calibration and confirmation purposes is the spectrophotometer. The spectrophotometer measures the reflectance and/or transmittance of an object at a number of wavelengths throughout the visible spectrum. More specifically, the spectrophotometer exposes a test image to a known light source and then analyzes the light that is reflected by the test image to determine the spectral intensity. A typical spectrophotometer is capable of measuring a group of pixels in an image. It includes an apparatus that measures the light that is reflected by a portion of an image at a number of wavelengths throughout the visible spectrum to obtain data that represents the true spectral content of the reflected light.

The use of such stand-alone spectrophotometers for proofing is very costly. Part of this cost is created by the inherent redundancy of many of the systems used in those devices. For example, a stand-alone spectrophotometer has an “X-Y” table to move the test image relative to the spectrophotometer. A digital color printer or proofer also contains an “X-Y” displacement mechanism for moving the paper and printing element or printhead. Similarly, both the spectrophotometer and the proofer contain separate electrical control systems, motors and other components. Thus, the total cost of the proofing system, including a separate stand-alone spectrophotometer and a proofer, is very high.

Installation and maintenance costs are also high because two separate devices, typically manufactured by different vendors, must be separately purchased, installed, and maintained. Various makes and models of spectrophotometers are used for color management and, since there is significant measurement bias between devices, considerable measurement variability results. Finally, there is a significant labor cost associated with making calibration and color management adjustments to the proofer using a stand-alone spectrophotometer. Accordingly, there are substantial cost and efficiency penalties associated with stand-alone proofing combinations.

### SUMMARY OF THE INVENTION

The present invention provides a system and method to reduce the time to measure a color in a proof printing system by using a spectrophotometer integrated with a printer. In one embodiment, an ink color patch is printed on a substrate (which may be, for example, paper or other material suitable for printing on), the color patch is illuminated with light from the spectrophotometer (when the substrate is still located on the printer), light that is reflected off the color patch is collected by the spectrophotometer, an output signal is generated by the spectrophotometer (which is based on collected light reflected by the color patch) which is input to a controller. The controller is coupled to the spectrophotometer, a temperature measurement device, a humidity measurement device, a support surface (such as, for example, a platen moving in X-Y, a platen moving in Y with a print head moving in X, and/or the like) and a print head. The controller uses the output signal from the spectrophotometer, the humidity measurement and temperature measurement to access its preprogrammed internal color adjustment dry-rate lookup table (which may contain, such as, for example, the spectrophotometer model, printer model, paper type, ink type, temperature, humidity and the like which point to, such as, for example, a color profile, a color profile with different colors of backing material, a color profile with an ultraviolet (UV) filter, a color profile without the UV filter, a color profile based on different standards, and the like) to adjust the present spectrophotometer output signal to that of what it would be at a goal color. In other words, since the presently measured color will result in the goal color, the spectrophotometer output is adjusted to what it would be at the goal color. As a consequence, a user does not need to wait to see if the goal color results since the presently measured color has been pre-determined to result in the goal color.

With this embodiment, a method for adjusting the output signal of the spectrophotometer integrated with the printer is disclosed. In particular, the ink color patch is printed on the substrate using the printer; the color patch is illuminated with the incident light while the substrate is located in the printer, thereby obtaining an output signal from the spectrophotometer based on light reflected by the color patch; and the output signal of the spectrophotometer is adjusted based on at least one of printing conditions and measurement conditions. Additionally, a system for adjusting the output signal of the spectrophotometer integrated with the printer is disclosed where the printer is for printing an ink color patch on the substrate; the illumination source, internal to the spectrophotometer, is for illuminating the color patch while the substrate is located in the printer, thereby obtaining the output signal from the spectrophotometer based on light reflected by the color patch; and the controller coupled to the printer and spectrophotometer is for adjusting the output signal of the spectrophotometer.

In another embodiment of the present invention, the ink color patch is printed on the substrate, a measurement delay time (determined from the preprogrammed internal color adjustment dry-rate lookup table) to attain a color that is within and including a reference color tolerance of the goal color is implemented by the controller, then the color patch is illuminated with the light from the spectrophotometer (when the substrate is still located in the printer), light that is reflected off the color patch is collected by the spectrophotometer, the output signal is generated by the spectrophotometer (which is based on collected light reflected by the color patch) which is input to the controller. The controller is coupled to the spectrophotometer, the temperature measurement device, the humidity measurement device, the support surface and the print head.

With this embodiment, a method for measuring the output of the spectrophotometer integrated with the printer is disclosed. In particular, the ink color patch is printed on the substrate using the printer; a measurement delay time is implemented after the printing for the color patch to dry to the predetermined degree of dryness; and the color patch is illuminated with the incident light while the substrate is located in the printer, thereby obtaining the output signal from the spectrophotometer based on light reflected by the color patch. Additionally, a system for measuring the output of a spectrophotometer integrated with a printer is disclosed where the printer is for printing the ink color patch on the substrate; the illumination source internal to a spectrophotometer is for illuminating the color patch while the substrate is located in the printer, thereby obtaining the output signal from the spectrophotometer based on light reflected by the color patch; and the controller coupled to the printer and spectrophotometer is for providing the measurement delay time before the controller measures the output signal.

In another embodiment of the present invention, the ink color patch is printed on the substrate, a drying delay time (determined from the preprogrammed internal color adjustment dry-rate lookup table) is implemented by the controller, then the color patch is illuminated with the light from the spectrophotometer (when the substrate is still located on the printer), light that is reflected off the color patch is collected by the spectrophotometer, the output signal is generated by the spectrophotometer (which is based on collected light reflected by the color patch) which is input to the controller. The controller is coupled to the spectrophotometer, the temperature measurement device, the humidity measurement device, the drum and the print head. The controller uses the output signal from the spectrophotometer, the humidity measurement and temperature measurement to access its preprogrammed internal color adjustment dry-rate lookup table to adjust the spectrophotometer output signal to that of what it would be at a goal color. In other words, since the presently measured color will result in the goal color, the spectrophotometer output is adjusted to what it would be at the goal color. As a consequence, a user does not need to wait to see if the goal color results since the presently measured color has been pre-determined to result in the goal color.

With this embodiment, a method for adjusting the output signal of the spectrophotometer integrated with a printer is disclosed. In particular, the ink color patch is printed on the substrate using the printer; the drying delay time is implemented after the printing; the color patch is illuminated with the incident light while the substrate is located in the printer, thereby obtaining the output signal from the spectrophotometer based on light reflected by the color patch; and the output signal of the spectrophotometer is adjusted based on at least one of printing conditions and measurement conditions. Additionally, a system for adjusting the output signal of the spectrophotometer integrated with a printer is disclosed where the printer is for printing an ink color patch on the substrate; the illumination source internal to the spectrophotometer is for illuminating the color patch while the substrate is located in the printer, thereby obtaining the output signal from the spectrophotometer based on light reflected by the color patch; and; the controller coupled to the printer and spectrophotometer is for providing the drying delay time before the controller measures the output signal and for adjusting the output signal of the spectrophotometer.

The present invention may also provide for the output signal to be adjusted to compensate for a color of the background against which the printing substrate is positioned at the time of measurement of the color patch and also to compensate for the presence or absence of ultraviolet illumination in the illuminating light of the spectrophotometer. The present invention may also allow for the output of the spectrophotometer to be adjusted based on an internal color standard that is calibrated against a reference color standard.

The present invention also makes use of the spectrophotometer output signal for the purpose of color calibration and confirmation. In regard to calibration, by correcting all printers of this type in the same manner, the invention is able to print the same perceivable colors on any device. This is particularly valuable, in that an electronic image can be sent rapidly to anywhere in the world where the invention exists and will be able to produce the same perceivable colors on all such calibrated devices.

In regard to color confirmation a process is used to judge the color quality of a proof. This is accomplished by manually printing a color target on a substrate and using human observation or a spectrophotometer measurement to determine a pass/fail judgment by comparing the target containing a set of patches to a fixed reference target containing a set of color patches.

In a further embodiment of the present invention, the spectrophotometer output signal is used to compute how a human observer would perceive the color patch; then the numeric representation of human perceived color is fed back into an algorithm within the controller and compared to that of a reference standard against a tolerance in order to render a pass/fail judgment. Typically, a sticker is placed on a printed page in order to indicate its quality level. With the present invention, the system can automatically print such label directly on the printed substrate without user intervention, using the adjusted spectrophotometer output signal along with suitable computer algorithms contained in the controller. The system is therefore able to perform color measurement, calibration, and confirmation without human intervention.

### BRIEF DESCRIPTION OF THE DRAWINGS

The present invention will be more readily understood from the detailed description of exemplary embodiments presented below considered in conjunction with the attached drawing:

FIG. 1 shows a block diagram of a proof printing system with an integrated spectrophotometer.

It is to be understood that the attached drawing is for purposes of illustrating the concepts of the invention and may not be to scale.

### DETAILED DESCRIPTION OF THE INVENTION

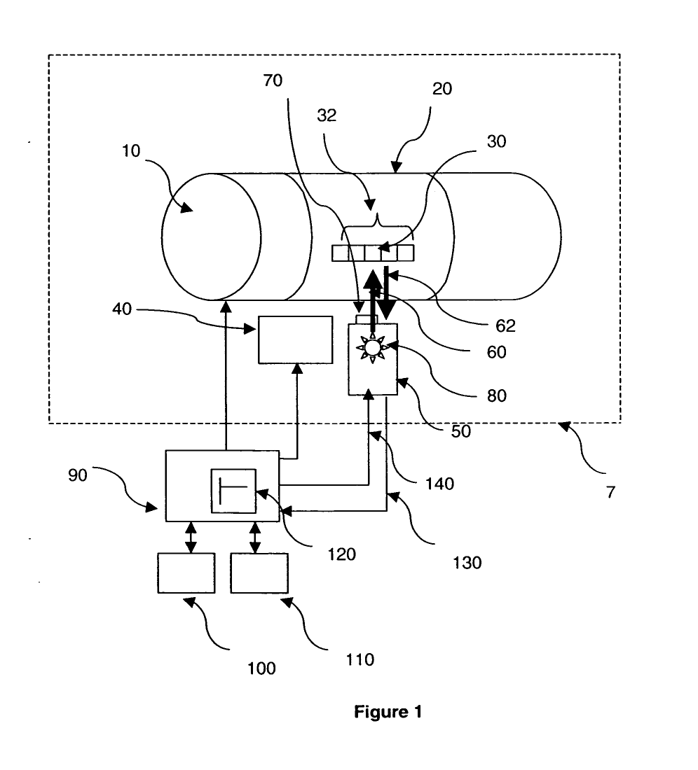

Referring to FIG. 1, a proof printing system 5 of the present invention is illustrated. System 5 includes a printer 7, a controller 90 coupled to the printer 7, a humidity sensor 100 coupled to the controller 90 and a temperature sensor 110 coupled to the controller 90. Printer 7 is preferably a commercial printer and has a spectrophotometer 50 integrated with it. Drum 10 is internal to printer 7. Drum 10 and a print head 40 are coupled to the controller 90. The spectrophotometer 50, which contains an illumination source 80, is coupled to the controller 90. An ultraviolet (UV) filter 70 is coupled to the spectrophotometer 50. A substrate 20 is coupled to the drum 10 and a color target 32 containing color patch 30 (which is one of one or more color patches that form color target 32) is printed on substrate 20. Drum 10 is preferably a printer drum; however, it may also be a platen or any other suitable type of printing support surface.

In operation, the print head 40 prints the color patch 30 on the substrate 20; spectrophotometer 50 illuminates color patch 30 with an incident light 60, preferably with the UV filter 70 in the of the incident light path 60, measures a reflected light 62, and assigns a numerical color value to the color measured in the reflected light 62; and the controller 90 receives the numerical color value determined by the spectrophotometer 50 via output signal 130, whether analog, digital or the like. The printer 7 is controlled by the controller 90. The controller 90 is capable of adjusting the output signal 130 based on measurement conditions and printing conditions, as addressed below. The humidity sensor 100 and temperature sensor 110 provide the controller 90 with the ability to determine the humidity and the temperature, respectively, at times selected by the controller 90. These times can include, but are not limited to, the time when printing happens and the time when the spectrophotometer 50 measures the color of the color patch 30. The controller 90 may also perform one or more of the following functions (a) adjust the output signal 130 of the spectrophotometer 50 to compensate for a color of backing, which is preferably the color of drum 10, under the substrate 20, (b) adjust the output signal 130 of the spectrophotometer 50 to compensate for the presence or absence of the UV filter 70 in path of the incident light 60 and (c) adjust the output signal 130 of the spectrophotometer 50 based on a reference color standard traceable to one of a United States national and/or international standards authority.

When the color patch 30 is printed on the substrate 20, the color of color patch 30 changes as it dries. It can take over a day for the color patch 30 to completely dry. As a consequence, a color confirmation method is used. With this method, the color patch 30 is appended to every substrate 20 printed. A criterion is set for the maximum allowable variation in color that will be allowed from the color patch 30, known as a “color tolerance.” A sufficient number of color patches are chosen to ensure that particular print jobs are printing within the allowable color tolerance. This number can vary with the specific kind of printer used. Typically, 26 color patches are employed. Color patch 30 is measured as shortly as practically possible after printing the color patch 30 on the substrate 20, while the substrate 20 is still on the drum 10, thereby allowing color accuracy to be confirmed for the color patch 30. The present invention may include color patches that conform to one of the international standards such as SWOP or FOGRA. These standards have varying requirements in regard to the backing material (such as, for example, black or white) used for measuring and filtering reflected light 62.

A color calibration method may also be used by the present invention when it determines that a calibration is required. This can be due to a number of triggers or criteria which include, but are not limited to, a failure in color confirmation, changes in ink lots, changes in paper lots or when too much time has expired since the last calibration. Controller 90 may also be programmed to perform calibrations at regular intervals when the printer 7 has not been used for production prints. This can, for example, be done in the middle of the night or between shifts. Color calibration includes printing color patch 30, waiting for the color patch 30 to dry to a specific degree, measuring the color patch 30 with the spectrophotometer 50, where controller 90 adjusts the inking for a particular color value to achieve the correct printed color. Because the color calibration must be accurate, the controller 90 waits a predetermined length of time to allow color patch 30 to dry to a certain degree. In an exemplary case, the predetermined length of drying time is substantially 15 minutes. To improve accuracy, multiple color patches may be printed where each color patch 30 is measured multiple times. Additionally, printer 7 may employ different makes and models of commercial printers. The purpose of calibration is to ensure that every printer of a given make and model behaves identically to any other printer of the same make and model. Therefore, preprogrammed internal color adjustment dry-rate lookup table 120 need only be developed once for a particular combination of printer model, paper type, and ink type. This has the additional advantage that the color patch 30 will appear identical on a plurality of different printers, even at remote sites.

With the present invention, for both color confirmation and calibration, either control a delay time between printing the color patch 30 and measuring it with the spectrophotometer 50 and/or adjust the output signal 130 of the spectrophotometer 50 to compensate for the difference in color between the color at the time of measurement and the color that will result after a certain amount of drying (from the preprogrammed internal color adjustment dry-rate lookup table 120). Color confirmation and calibration measurements are substantially taken 15 to 60 minutes after color patch 30 is printed. In the general case, the “goal color” can be selected for the color patch 30 so that the color of the patch does not substantially vary due to drying over the period during which the color patch 30 will be viewed by a user. For the purposes of compensating for drying, the color at substantially 15 minutes after printing is deemed to be the “reference color” which is a particularly preferred case of the goal color.

In one embodiment, the ink color patch 30 is printed on the substrate 20, the color patch 30 is illuminated with the light 60 from the spectrophotometer 50 (when the substrate 20 is still located on the drum 10), light of reflected light 62 that is reflected off the color patch 30 is collected by the spectrophotometer 50, the output signal 130 is generated by the spectrophotometer 50 (which is based on the light 60 reflecting off the color patch 30 to create the reflected light 62) which is input to the controller 90. The controller 90 uses the output signal 130 from the spectrophotometer 50, the humidity sensor 100 and temperature sensor 110 to access its preprogrammed internal color adjustment dry-rate lookup table 120 to adjust the present spectrophotometer 50 output signal 130 value to that value from table 120 which is what the spectrophotometer 50 would measure at the goal color. In other words, since the presently measured color patch 30 will result in the goal color, the spectrophotometer 50 output signal 130 is adjusted to what it would be at the goal color. As a consequence, a user does not need to wait to see if the goal color results since the presently measured color patch 30 has been predetermined to result in the goal color.

In this case, there is no forced delay between printing the color patch 30 and measuring the color patch 30 with the spectrophotometer 50 since the drying rate of color patch 30 is listed in table 120. For a particular combination of inks, such as, for example, CMYK (cyan, magenta, yellow and black), at particular drying conditions of, but not limited to, temperature and humidity, determined as being the “printing conditions” at the time of printing, the drying characteristic of the color is readily determined. The color change due to drying tends to follow a decay curve that is similar to an exponential decay curve. The rate of change is greatest immediately after printing and then slows down as time passes. The drying characteristic (color variation as a function of time) can be measured and inserted into table 120 for a large number of combinations of inking and drying conditions. The drying characteristic for a particular inking and drying condition can also be interpolated from previously measured values. In this way, the goal color can be determined from the color measurement taken at any given time after printing the color patch 30. The color value adjustment due to drying is applied to the spectral data (in the reflected light 62) collected by the spectrophotometer 50 by adjusting the output signal 130 of the present spectrophotometer 50 output signal 130 to that of what is accessed in the table 120. The adjustment may also be applied to the data after conversion to either CIE XYZ or CIE L*a*b* color spaces as defined by the Commission Internationale de l'Eclairage.

In another embodiment of the present invention, the ink color patch 30 is printed on the substrate 20, a measurement delay time (determined from the preprogrammed internal color adjustment dry-rate lookup table 120) to attain a color that is within a reference color tolerance of the goal color is implemented by the controller 90, then the color patch 30 is illuminated along incident light path 60 from the spectrophotometer 50 (when the substrate 20 is still located on the drum 10), light that is reflected off color patch 30, travels along reflected light path 62 and is collected by the spectrophotometer 50, output signal 130 is generated by the spectrophotometer 50 (which is based on the light reflected by color patch 30 along reflected light path 62, and collected light reflected by color patch 30), which is input to the controller 90. The controller 90 is coupled to the spectrophotometer 50, temperature sensor 110, humidity sensor 100, drum 10 and print head 40. The humidity and temperature sensors 100 and 110, respectively, determine the conditions at the time of printing the color patch 30. The “printing conditions” in general, for all embodiments, may include, but are not limited to, the temperature, the humidity, choice of substrate 20 and the choice of ink for the color patch 30. The table 120 indicates the measurement delay time required to get to or within a specified color difference or “tolerance” of the goal color of the color patch 30 printed on the substrate 20. With this embodiment, this tolerance is referred to as the “reference color tolerance.” The measurement delay time is a function of temperature and humidity. At high temperature and low humidity conditions, the color of the color patch 30 may converge to or within a color difference or “reference color tolerance” of 0.5 dE of the goal color in substantially 3 to 4 minutes. With the present invention, dE is used to represent the color difference in CIE-L*a*b* color space where dE=SQRT ((dL*)ˆ2+(da*)ˆ2+(db*)ˆ2), wherein dL* is the difference in lightness, da* is the difference in a* (red-green) and db* is the difference in b* (yellow-blue) as measured in CIE-L*a*b* color space. At low temperature and high humidity conditions, the color of the color patch 30 may converge to within 0.5 dE of the goal color in substantially 15 minutes.

In another embodiment of the present invention, the ink color patch 30 is printed on the substrate 20, a drying delay time (determined from the preprogrammed internal color adjustment dry-rate lookup table 120) is implemented (the rate of drying is selected on the basis of a balance between having a slow drying rate, yet having the shortest possible delay. This delay time is referred to as the “drying delay time.”), then the color patch 30 is illuminated along incident light path 60 from the spectrophotometer 50 (when the substrate 20 is still located on the drum 10), light that is reflected off the color patch 30 along reflected light path 62, is collected by the spectrophotometer 50, the output signal 130 is generated by the spectrophotometer 50 (which is based on light reflected by the color patch 30 along the reflected light path 62, and collected by the spectrophotometer 50) which is input to the controller 90. The controller 90 is coupled to the spectrophotometer 50, temperature sensor 110, humidity sensor 100, drum 10 and print head 40. The controller 90 uses the output signal 130 from the spectrophotometer 50, the humidity sensor 100 and the temperature sensor 110 (herein “measurement conditions”) to access its preprogrammed internal color adjustment dry-rate lookup table 120 to adjust the spectrophotometer 50 output 130 to what it would be at the goal color. As a consequence, a user does not need to wait to see if the goal color results since the presently measured color patch 30 has been pre-determined to result in the goal color.

With any of the above embodiments, the term “measurement conditions” is used to describe the circumstances of the measurement, which may include, but are not limited to, the choice of color of a backing behind substrate 20, the presence or absence of ultraviolet filter 70, and the choice of particular make, model and serial number of spectrophotometer 50 employed. Measurements taken of the color patch 30 against a white backing differ from the color patch 30 measured against a black backing. This is because the substrate 20 is not completely opaque. Light reflected from the color patch 30 measured against the black backing is less than the light reflected from the color patch 30 measured against the white backing since the two measurements are affected by the type of substrate 20 used, the type of ink used, and the amount of each ink color CMYK printed.

Additionally, with any of the above embodiments, measurements may be taken with the UV filter 70 in or out. Some industry standards, such as the FOGRA standard, require that measurements be taken without the UV filter 70. The controller 90 of the present invention may calculate the equivalent measurement taken without the UV filter 70 from the measurement taken with the UV filter 70. The calculation to address this difference is based on table 120 which contain measured responses comparing the spectrophotometer 50 readings done for a plurality of color patches for the system 5. For each of a plurality of colors, the difference is determined between the spectrophotometer 50 output signal 130 when measuring a given color patch 30 with and without the UV filter 70. In this fashion, the measured spectrophotometer 50 output signal 130 without the UV filter 70 can be determined by the measured spectrophotometer 50 output signal 130 with the UV filter 70. A separate table 120 may be determined for a number of combinations of ink, media and/or substrate 20. However, for calibration of system 5, it is beneficial to obtain measurements with the UV filter 70. Like the above, the controller 90 may also calculate, in a similar manner, the equivalent measurement taken with the UV filter 70 from a measurement taken without the UV filter 70.

The invention makes use of the spectrophotometer 50 output signal 130 for the purpose of color calibration. The calibration process is as follows: first a specific color target 32 (a set of color patches) is printed on the substrate 20, and automatically measured with the spectrophotometer 50. The spectrophotometer 50 output signal 130 is used to compute an ink correction that allows the printer 7 to produce consistent output. By correcting all printers of this type in the same manner, the invention is able to print the same perceivable colors on any device. This is particularly valuable, in that an electronic image can be sent rapidly to anywhere in the world where the invention exists and will be able to produce the same perceivable colors on all such calibrated devices.

In a preferred embodiment of the invention, the specific set of calibration colors will be printed as color target 32, containing color patch 30, on every page printed by the printer 7, measured automatically with the spectrophotometer 50, and fed back into controller 90 for an algorithmic correction after completing every print, thereby performing calibration on a continuous basis. This is valuable because the invention is able to print continuously without stopping to perform a color calibration, thus increasing the throughput of the system.

The invention also makes use of the spectrophotometer 50 output signal 130 for the purpose of color confirmation. Color confirmation is the process of judging the color quality of a proof. This is typically accomplished by manually printing a color target on a substrate and using human observation or a spectrophotometer measurement to determine a pass/fail judgment by comparing the target containing a set of patches to a fixed reference target containing a set of color patches.

With the present invention, the spectrophotometer 50 output signal 130 is used to compute how a human observer would perceive the color patch 30; then the numeric representation of human perceived color is fed back into an algorithm within controller 90, and compared to that of a reference standard against a tolerance, in order to render a pass/fail judgment.

In a preferred embodiment of the invention, the spectrophotometer 50 output signal 130 is adjusted for a specific degree of dryness, backing material, presence or absence of the UV filter 70, and/or other like measurement condition, in order to improve the comparison to that of published reference standards for purposes of color confirmation.

Typically, a sticker is placed on a page output in order to indicate its quality level. In a preferred embodiment of the invention, the system 5 automatically prints such a label directly on the printed substrate 20 without user intervention, using the adjusted spectrophotometer 50 output signal 130 along with suitable computer algorithms contained in controller 90. The system 5 is therefore able to perform color measurement, color calibration, and color confirmation without human intervention.

It is to be understood that the embodiments contained herein are merely illustrative of the present invention and that many variations of the above-described embodiments may be devised by one skilled in the art without departing from the scope of the invention. It is therefore intended that all such variations be included within the scope of the following claims and their equivalents.

1. A method for adjusting an output signal of a spectrophotometer integrated with a printer, the method comprising the steps of:
printing an ink color patch on a substrate using the printer;
illuminating the color patch with an incident light while the substrate is located in the printer, thereby obtaining an output signal from the spectrophotometer based on light reflected by the color patch; and
adjusting the output signal of the spectrophotometer based on at least one of printing conditions and measurement conditions.

2. The method of claim 1, wherein the ink color patch is part of a calibration test image.

3. The method of claim 1, wherein the substrate is paper.

4. The method of claim 1, wherein the incident light contains ultraviolet light.

5. The method of claim 1, wherein the incident light does not contain ultraviolet light.

6. The method of claim 1, wherein the printing conditions include temperature and humidity.

7. The method of claim 6, wherein the adjusting step further comprises using a value obtained from a stored table.

8. The method of claim 7, wherein the table values provide compensation for the amount of time it takes the ink to dry to a goal color.

9. The method of claim 8, wherein the illuminating step further comprises using an ultraviolet filter in the incident light path at the time of obtaining the output signal.

10. The method of claim 9, wherein the output signal of the spectrophotometer is adjusted to a value from the table that is equivalent to the output signal obtained if there is no ultraviolet filter in the incident light path.

11. The method of claim 8, wherein the illuminating step further comprises not using an ultraviolet filter in the incident light path at the time of obtaining the output signal.

12. The method of claim 11, wherein the output signal of the spectrophotometer is adjusted to a value from the table that is equivalent to the output signal obtained if there is an ultraviolet filter in the incident light path.

13. The method of claim 8, wherein the illuminating step further comprises using a first color background behind the substrate at the time of obtaining the printing conditions, measurement conditions and output signal.

14. The method of claim 13, wherein the output signal of the spectrophotometer is adjusted to a value from the table that is equivalent to the output signal obtained if there is a second color background behind the substrate.

15. The method of claim 1, wherein the adjusting step further comprises using a reference color standard.

16. A method for measuring an output of a spectrophotometer integrated with a printer, the method comprising the steps of:
printing an ink color patch on a substrate using the printer;
waiting a measurement delay time after the printing for the color patch to dry to a predetermined degree of dryness; and
illuminating the color patch with an incident light while the substrate is located in the printer, thereby obtaining an output signal from the spectrophotometer based on light reflected by the color patch.

17. The method of claim 16, wherein the ink color patch is part of a calibration test image.

18. The method of claim 16, wherein the substrate is paper.

19. The method of claim 16, wherein the incident light contains ultraviolet light.

20. The method of claim 16, wherein the incident light does not contain ultraviolet light.

21. The method of claim 16, further comprising the steps of measuring printing conditions of temperature and humidity and measurement conditions of the output signal.

22. The method of claim 21, wherein the measurement delay time is based on a predetermined drying rate values from a software table for the ink under the printing conditions.

23. The method of claim 22, wherein the measurement delay time allows for the color patch to dry to a color that is within a predetermined reference color tolerance of a goal color.

24. The method of claim 23, wherein the predetermined reference color tolerance is less than or equal to 0.5 dE.

25. The method of claim 23, wherein the illuminating step further comprises using an ultraviolet filter in the incident light path at the time of obtaining the signal.

26. The method of claim 25, wherein the output signal of the spectrophotometer is adjusted to a value from the table that is equivalent to the output signal obtained if there is no ultraviolet filter in the incident light path.

27. The method of claim 23, wherein the illuminating step further comprises not using an ultraviolet filter in the incident light path at the time of obtaining the printing conditions, measurement conditions and output signal.

28. The method of claim 27, wherein the output signal of the spectrophotometer is adjusted to a value from the table that is equivalent to the output signal obtained if there is an ultraviolet filter in the reflected light path.

29. The method of claim 23, wherein the illuminating step further comprises using a first color background behind the substrate at the time of obtaining the printing conditions, measurement conditions and output signal.

30. The method of claim 29, wherein the output signal of the spectrophotometer is adjusted to a value from the table that is equivalent to the output signal obtained if there is a second color background behind the substrate.

31. A method for adjusting an output signal of a spectrophotometer integrated with a printer, the method comprising the steps of:
printing an ink color patch on a substrate using the printer;
waiting a drying delay time after the printing;
illuminating the color patch with an incident light while the substrate is located in the printer, thereby obtaining an output signal from the spectrophotometer based on light reflected by the color patch; and
adjusting the output signal of the spectrophotometer based on at least one of printing conditions and measurement conditions.

32. The method of claim 31, wherein the ink color patch is part of a calibration test image.

33. The method of claim 31, wherein the substrate is paper.

34. The method of claim 31, wherein the incident light contains ultraviolet light.

35. The method of claim 31, wherein the incident light does not contain ultraviolet light.

36. The method of claim 31, wherein the printing conditions include temperature and humidity.

37. The method of claim 36, wherein the measurement conditions include the output signal from the spectrophotometer.

38. The method of claim 36, wherein the drying delay time is based on a predetermined drying rate value from a software table for the ink under the printing conditions.

39. The method of claim 38, wherein the illuminating step further comprises using an ultraviolet filter in the incident light path at the time of obtaining the output signal.

40. The method of claim 39, wherein the output signal of the spectrophotometer is adjusted to a value from the table that is equivalent to the output signal obtained if there is no ultraviolet filter in the incident light path.

41. The method of claim 38, wherein the illuminating step further comprises not using an ultraviolet filter in the incident light path at the time of obtaining the printing conditions, measurement conditions and output signal.

42. The method of claim 41, wherein the output signal of the spectrophotometer is adjusted to a value from the table that is equivalent to the output signal obtained if there is an ultraviolet filter in the incident light path.

43. The method of claim 38, wherein the illuminating step further comprises using a first color background behind the substrate at the time of obtaining the printing conditions, measurement conditions and output signal.

44. The method of claim 43, wherein the output signal of the spectrophotometer is adjusted to a value from the table that is equivalent to the output signal obtained if there is a second color background behind the substrate.

45. The method of claim 31, wherein the adjusting step further comprises using a reference color standard.

46. A system for adjusting an output signal of a spectrophotometer integrated with a printer, the system comprising:
a printer for printing an ink color patch on a substrate;
an illumination source internal to a spectrophotometer for illuminating the color patch while the substrate is located in the printer, thereby obtaining an output signal from the spectrophotometer based on light reflected by the color patch; and
a controller coupled to the printer and spectrophotometer for adjusting the output signal of the spectrophotometer.

47. The system of claim 46, wherein the ink color patch is part of a calibration test image.

48. The system of claim 46, wherein the substrate is paper.

49. The system of claim 46, wherein the illumination source emits ultraviolet light.

50. The method of claim 46, wherein the illumination source does not emit ultraviolet light.

51. The system of claim 46, wherein the controller adjusts the output of the spectrophotometer by using measurement conditions and printing conditions which include temperature and humidity.

52. The system of claim 46, wherein the printer is a commercial printer.

53. The system of claim 46, wherein the controller is a personal computer.

54. A system for measuring an output of a spectrophotometer integrated with a printer, the system comprising:
a printer for printing an ink color patch on a substrate;
an illumination source internal to a spectrophotometer for illuminating the color patch while the substrate is located in the printer, thereby obtaining an output signal from the spectrophotometer based on light reflected by the color patch; and
a controller coupled to the printer and spectrophotometer for providing a measurement delay time before the controller measures the output signal.

55. The system of claim 54, wherein the ink color patch is part of a calibration test image.

56. The system of claim 54, wherein the substrate is paper.

57. The system of claim 54, wherein the illumination source emits ultraviolet light.

58. The method of claim 54, wherein the illumination source does not emit ultraviolet light.

59. The system of claim 54, wherein the printer is a commercial printer.

60. The system of claim 54, wherein the controller is a personal computer.

61. A system for adjusting an output signal of a spectrophotometer integrated with a printer, the system comprising:
a printer for printing an ink color patch on a substrate;
an illumination source internal to a spectrophotometer for illuminating the color patch while the substrate is located in the printer, thereby obtaining an output signal from the spectrophotometer based on light reflected by the color patch; and;
a controller coupled to the printer and spectrophotometer for providing a drying delay time before the controller measures the output signal and for adjusting the output signal of the spectrophotometer.

62. The system of claim 61, wherein the ink color patch is part of a calibration test image.

63. The system of claim 61, wherein the substrate is paper.

64. The system of claim 61, wherein the illumination source emits ultraviolet light.

65. The method of claim 61, wherein the illumination source does not emit ultraviolet light.

66. The system of claim 61, wherein the printer is a commercial printer.

67. The system of claim 61, wherein the controller is a personal

68. The system of claim 61, wherein the controller adjusts the output of the spectrophotometer by using measurement conditions which include temperature and humidity.
